(19) United States
(12) Patent Application Publication
(10) Pub. No.: US 2024/0116060 A1
(43) Pub. Date: Apr. 11, 2024

(54) PREPARATION OF BUILDING MIXTURES AND PROCESSING MATERIALS USING MICRO-PULSE MICRO-ARC PROCESSING

(71) Applicant: Joseph Brifman, Flagler Beach, FL (US)

(72) Inventor: Joseph Brifman, Flagler Beach, FL (US)

(21) Appl. No.: 18/516,044

(22) Filed: Nov. 21, 2023

Related U.S. Application Data
(63) Continuation-in-part of application No. 17/238,759, filed on Apr. 23, 2021.
(60) Provisional application No. 63/015,997, filed on Apr. 27, 2020.
(60) Provisional application No. 63/427,294, filed on Nov. 22, 2022.

(51) Int. Cl. B03C 1/24; B03C 1/005; B03C 1/033

(52) U.S. Cl. CPC B03C 1/24; B03C 1/005; B03C 1/0335

(57) ABSTRACT

A system for preparing and activating building mixtures and for refining materials by processing waste or raw materials and method of use. The system comprises a tubular reactor through which waste material is passed. The tubular reactor comprises an inductor configured to produce a rotating magnetic field. A plurality of needle-shaped ferromagnetic elements are disposed within a cylindrical working zone of the reactor. The needle-shaped ferromagnetic elements oscillate reaching several thousand periods per second. The system and method for processing natural, synthetic and waste material utilizes micro-pulse micro-arc processing of the material in the rotating magnetic fields to convert organic and inorganic waste into purified raw materials that are usable with minimal reprocessing, to preparing and activating building mixtures from raw materials, and to refine minerals and metals from ores, slags and tailings.

### CROSS-REFERENCE TO RELATED APPLICATION

The present application is a continuation in part application that claims priority to, and the benefit of, U.S. Non-provisional application Ser. No. 17/238,759, which was filed on Apr. 23, 2021, which claims priority to, and the benefit of, U.S. Provisional Application No. 63/015,997, which was filed on Apr. 27, 2020, and to U.S. Provisional Application No. 63/427,294, which was filed on Nov. 22, 2022, all of which are incorporated herein by reference in their entirety.

### FIELD OF THE INVENTION

The present invention generally relates to a system and method for preparing and activating building mixtures, and more specifically to a system and method for reprocessing most types of waste as well natural, synthetic and raw materials into major sources of key materials and building materials using a reactor that uses multiple short spark source discharges that are influenced by a rotating electromagnetic field. Accordingly, the present specification makes specific reference thereto. However, it is to be appreciated that aspects of the present invention are also equally amenable to other like applications, devices, and methods of manufacture.

### BACKGROUND OF THE INVENTION

By way of background, an ideal economy should self-sustaining and resilient. An ability to adjust to changes in population, economic growth, natural hazards and variability in production and demand requires a level of sophistication at all stages of production, processing, and waste management. A major limitation is the use and re-use of water and the optimization of all systems using best available technologies to approach the concept of zero waste.

Many technologies that are presented for dealing with environmental contaminants are either specific to the target, incremental improvements to existing technology, or need supplementary technology to deal with by-products created in the process or wasteful concentrates. The aim of a zero-waste system with zero discharges, accompanied by a lowered energy requirement, smaller footprint, and flexible design, as well as a fast start-up and shut-down to and from full operation, has been met in only a very few instances and even then only for a limited number of applications. Accordingly, industry and regulators are stuck with traditional technologies that have well known limitations. Small, incremental improvements over time or novel treatment technologies have added to the process trains but the goal of zero -discharges is missing.

In chemical treatment processes, impurities are removed as particles from the water as precipitates or colloids. These are accumulated in settling tanks prior to discharge in permitted areas or for delivery to shore based waste units. In some cases, they are adsorbed or accumulated onto other materials or targets such as in filtration or electrochemical systems. The shortcomings of existing systems using physical and chemical principles of purification include high construction and operating costs; the need for cleaning of units; complexity of the control and monitoring systems, large bulk and mass, and the need for specialized ventilation and additional safety measures for confined spaces. These are often combined with membrane or other types of filtration systems to remove residual solids or microorganisms. A further disadvantage of chemical treatment systems is that the treatment products prepared by these methods can contain residues of chemically active substances that are harmful to the aquatic and marine biosphere so that further treatments are required.

The biological treatment of wastewater uses bacteria that process impurities into a substance that can be removed by microbial conversion to energy or adsorbable species or gases amongst other forms. Biological treatment systems require creation and maintenance of optimal conditions for the existence and multiplication of bacteria, with considerable time required to put the plant into operation after prolonged interruptions to operation. While marine based biological systems with brackish or saltwater are now relatively common, they are sensitive to changes in feed water composition. Biochemical treatment units need to be continuously fed to avoid incomplete treatment or prolonged start up times. When the delivery of wastewater to the unit is reduced or stopped, the sludge biomass activity reduces with corresponding reductions in treatment efficacy sometimes for extended periods.

Widely used technologies and equipment for disposal of wastewater use multistage cleaning methods: reagent treatment, coagulation, aeration, sedimentation, filtration, neutralization of slimes, clarification and more. An important factor that degrades the technical and economic efficiency is the low process intensity in the operating zones due to relatively low concentrations of the active components. Processes are correspondingly slow so that the size of the equipment is large, with low material and energy efficiency.

A wastewater stream typically contains mixtures of various substances which are physically combined but may, or may not, be chemically combined in solid and liquid phases. These mixtures may differ in chemical and physical properties from the individual substances from which they originated. These solid-phase waste stream components may be settleable solids, suspended solids, or colloidal solids. The liquid-phase components may be colloids, soluble compounds, gases, or ions. Colloids are solids of such small size that they are dispersed with an adsorbed charge to maintain stasis in the liquid phase. These colloids are mixtures in which the particles are invisible to the naked eye, cannot be removed by filtration, but can be contained within a semi-permeable membrane. Solids may be encountered in liquids under several forms: slurries, solutions, colloidal dispersions, and solid suspensions.

Concrete is a composite material composed of aggregate bonded together with a fluid cement that cures over time. Concrete is the most widely used building material in the world. Aggregate is mixed with dry Portland cement and water to form a fluid slurry that is easily poured and molded into shape. The cement reacts with the water through a process called concrete hydration that hardens it over several hours to form a hard matrix that binds the materials together into a durable stone-like material that has many uses.

Hundreds of years have passed since humanity invented concrete and cement. It was a revolution in construction technologies. People stopped hollowing out monolithic stone blocks for construction, but began to cast the desired configurations of stone blocks right at the construction site. This significantly reduced the cost of obtaining and transporting the necessary materials to the construction site.

Construction technologies have been gradually improved, and construction materials have improved with them. New additives and plasticizers were invented. Concrete and constructional mixtures have gradually evolved. The concrete has become stronger. People have learned how to obtain materials for arctic applications, hot deserts and underwater works. Houses, spans of bridges, trestles and other large-sized structures began to be cast from concrete in the last century. Loads on load-bearing structures began to be measured in thousands of tons. The transportation of these structures has become the subject of scientific and engineering research. All of the above led to a serious study of the possibilities of lightening of reinforced concrete structures. However, there is significant room for innovation in production of constructional mixtures based on cement and concrete.

While processing ores, slags and tailings for improved recovery of valuable resources, traditional technologies such as initial grinding, milling, floatation, solvent chelating or acid leaching followed by precipitation are multi-stage processes with intensive use of chemicals, energy and other materials such as water. An additional issue is the treatment of wastewater and disposal of the treated water and byproducts. All traditional operations requiring direct contact of the ore with a solution are also relatively slow and of low efficiency.

Accordingly, there is a great need for a technology that enables the conversion of organic and inorganic sludges, mine tailing accumulations, sewage from all sources, industrial waste, and construction waste, into raw materials for reuse with minimal processing. There is also a need for a zero discharge processing of domestic and industrial wastes with on-site or local re-use Similarly, there is a need for a chemical treatment process that is not harmful to the aquatic and marine biosphere. There is also a need for a way to remove environmental contaminates that is flexible, requires low energy, and has a small footprint. There is an additional need for a way to produce building materials with new chemical and physical properties. There is further a need for a way to accelerate the dissolution and leaching processes and to increase the level of extraction of the target components from the ore without increasing the residues.

In this manner, the improved system of the present invention accomplishes all of the forgoing objectives, thereby providing an easy solution for converting sludges, mine tailing accumulations, sewage from all sources, industrial waste including organic and non-organic hazardous waste, and construction waste, into raw materials for reuse with minimal processing. A primary feature of the present invention is a way to convert organic waste into a high quality organic fertilizer by removing chemical impurities. The present invention allows for non-organic waste to be converted into metal oxides or stable chemical components for use as construction materials. The present invention can generate new materials and provide new synthesis pathways such as conversion of nitrogen and carbon to urea. Further, the improved system of the present invention is capable of reprocessing most types of waste into major sources of key materials while minimizing wastes from many existing industries, thereby preventing new accumulations while conserving and recycling water resources. Importantly, the system requires no major oxygen inputs as with biological processes and no biological inputs. Further, the improved system is capable of improving the performance characteristics of building materials, such as concrete, from converted raw materials. Finally, the system can process of ores, slags and tailings for improved recovery of valuable resources.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a system for processing waste material. The system generates micro arcs and power micro impulses to treat the waste material. The system comprises a tubular reactor and a plurality of ferromagnetic elements. The tubular reactor comprises a tubular chamber and an inductor. The tubular chamber comprises a shell and a cylindrical working area. The cylindrical zone is encapsulated by the shell. The shell is magnetically nonreactive with the inductor. The tubular chamber may further comprise a jacket. The jacket is an insulated sleeve that lines the shell.

The inductor comprises a magnetic circuit and a winding. The winding is configured to generate a rotating electromagnetic field within the tubular chamber uniformly distributed and perpendicular to its axis. The winding may be a symmetrical reduced two-layer loop. The tubular reactor further comprises a power regulator. The power regulator is in electrical communication with the inductor. The tubular reactor further comprises a reactor cooling component. The reactor cooling component is configured to cool the inductor with water or oil. The tubular reactor is further configured to regulate the frequency of the supplied power.

The plurality of ferromagnetic elements are positional within the cylindrical working area of the tubular chamber. The plurality of ferromagnetic elements are needle-shaped and configured to kinetically interact with the waste material when triggered by the rotating magnetic field generated by the inductor. The activated plurality of ferromagnetic elements generate the micro arcs and power micro impulses that kinetically treats the waste material. Depending on the waste material to be treated, the plurality of ferromagnetic elements may be coated with a catalytic metal or an elastic polymer shell.

The subject matter disclosed and claimed herein, in one embodiment thereof, comprises a method for processing waste material using a system for processing waste material. The system generates micro arcs and power micro impulses to treat the waste material. The method begins by pretreating the waste material using a traditional waste material treatment process. Pretreating is necessary to reduce the size of the waste materials to approximately 2 mm or less so that complete processing may be accomplished with the system. Normal screening or pretreatment processes are typically employed to achieve this. Then the pretreated waste material is treated with the system for processing waste material.

The system comprises a tubular reactor and a plurality of ferromagnetic elements. The tubular reactor comprises a tubular chamber and an inductor. The tubular chamber comprises a shell and a cylindrical working area. The cylindrical working area is encapsulated by the shell. The shell is magnetically nonreactive with the inductor. The tubular working chamber may further comprise a jacket. The jacket is an insulated sleeve that lines the shell.

The inductor comprises a magnetic circuit and a winding. The winding is configured to generate a rotating electromagnetic field within the tubular chamber uniformly distributed and perpendicular to its axis. The winding may be a symmetrical reduced two-layer loop. The tubular reactor further comprises a power regulator. The power regulator is in electrical communication with the inductor. The tubular reactor further comprises a reactor cooling component. The reactor cooling component is configured to cool the inductor with water or oil. The tubular reactor is further configured to regulate the frequency of the supplied power.

The plurality of ferromagnetic elements are positional within the cylindrical working area of the tubular working chamber. The plurality of ferromagnetic elements are needle-shaped and configured to kinetically interact with the waste material when activated by the rotating magnetic field generated by the inductor. The activated plurality of ferromagnetic elements generate the micro arcs and power micro impulses that kinetically treats the waste material. Depending on the waste material to be treated, the plurality of ferromagnetic elements may be coated with a catalytic metal or an elastic polymer shell.

The method continues by separating the treated waste material into usable component materials. The method may further comprises retreating at least a portion of the treated waste material with the system for treating waste material. Once retreated, the retreated waste material is separated into usable component materials.

The subject matter disclosed and claimed herein, in another embodiment thereof as method for processing constructional material mixture using the system for processing material. The system generates micro arcs and power micro impulses to treat the constructional material mixture. The method begins by treating the constructional material mixture with the system for processing material using a rotating electromagnetic field using microarcs and power micro pulses at values of magnetic field induction in a working area of a tubular reactor. The system comprises the tubular reactor and the plurality of ferromagnetic elements and uses a rotating electromagnetic field using microarcs and power micro pulses at values of magnetic field induction in the working area of the tubular reactor, which contains ferromagnetic needle elements. The constructional material mixture may comprise sand and cement, or other building components.

The method continues by separating the treated constructional material mixture into usable component materials which comprises subsequent separation of the obtained fractions (products) after treatment of the constructional material mixture in a rotating electromagnetic field using microarcs and power micro pulses. The method may further comprises retreating at least of portion of the treated constructional material mixture with the system for processing material. Once retreated, the retreated constructional material mixture is separated into usable component material.

The subject matter disclosed and claimed herein, in another embodiment thereof as method of recovering minerals and metals using the system for processing material. The system generates micro arcs and power micro impulses to treat ores, slags, or tailings. The method begins by treating ores, slags, or tailings with the system for processing material using a rotating electromagnetic field using microarcs and power micro pulses at values of magnetic field induction in a working area of a tubular reactor. The method continues by separating and recovering the minerals and metals from the treated ores, slags, or tailings. The system comprises the tubular reactor and the plurality of ferromagnetic elements and uses a rotating electromagnetic field using microarcs and power micro pulses at values of magnetic field induction in the working area of the tubular reactor.

The method continues by separating the treated ores, slags, or tailings into usable minerals and metals which comprises subsequent separation of the obtained fractions (products) after treatment of the ores, slags, or tailings in a rotating electromagnetic field using microarcs and power micro pulses. The method may further comprises retreating at least of portion of the treated ores, slags, or tailings with the system for processing material. Once retreated, the retreated ores, slags, or tailings are separated into usable minerals and metals.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of a system for processing waste material of the present invention in accordance with the disclosed architecture.

FIG. 2 illustrates a rear perspective view of the system for processing waste material of the present invention in accordance with the disclosed architecture.

FIG. 3 illustrates an image of an operating zone of the system for processing waste material of the present invention in accordance with the disclosed architecture.

FIG. 4 illustrates a side cutaway view of a tubular reactor of the system for processing waste material of the present invention in accordance with the disclosed architecture.

FIG. 5 illustrates an end cutaway view of the tubular reactor of the system for processing waste material of the present invention in accordance with the disclosed architecture.

FIG. 6 illustrates a schematic view of a three-phase two-pole loop double-layer with a short pitch stator winding scheme of the tubular reactor of the system for processing waste material of the present invention in accordance with the disclosed architecture.

FIG. 7 illustrates a chart illustrating a differential between results of using a rotating magnetic field of the system for processing waste material versus using a traditional mixer to process waste.

FIG. 8 illustrates a schematic view of a method of processing waste material of the present invention using the system for processing waste material in accordance with the disclosed architecture.

FIG. 9 illustrates a schematic view of the method of processing waste material of the present invention using the system for processing waste material in accordance with the disclosed architecture.

FIG. 10 illustrates a chart illustrating results of using the system for processing waste material for the wastewater treatment of fish processing enterprises of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a system and method for using micro arc processing in a rotating magnetic field for high purification of urban domestic and industrial wastewater and sewage sludge with minimum energy consumption. It can also be the basis for the construction of sewage treatment systems of inhabited locality used local and centralized sewerage (sanatoriums, hospitals, schools, hotels, offices and shopping complexes), as well as treatment facilities of any type of industrial enterprises, including food and light industry, processing of agricultural products, industrial livestock farms, poultry farms, etc.

The present invention, in another exemplary embodiment, is a system and method for using micro arc processing in a rotating magnetic field for passing constructional mixtures in the required proportions through a tubular reactor, where inductor generates a high-energy rotating electromagnetic field to treat constructional mixtures and generate improved building materials. The system and method may further treat other raw materials and ore achieving significant increases in the efficiency of ore processing and metal recovery.

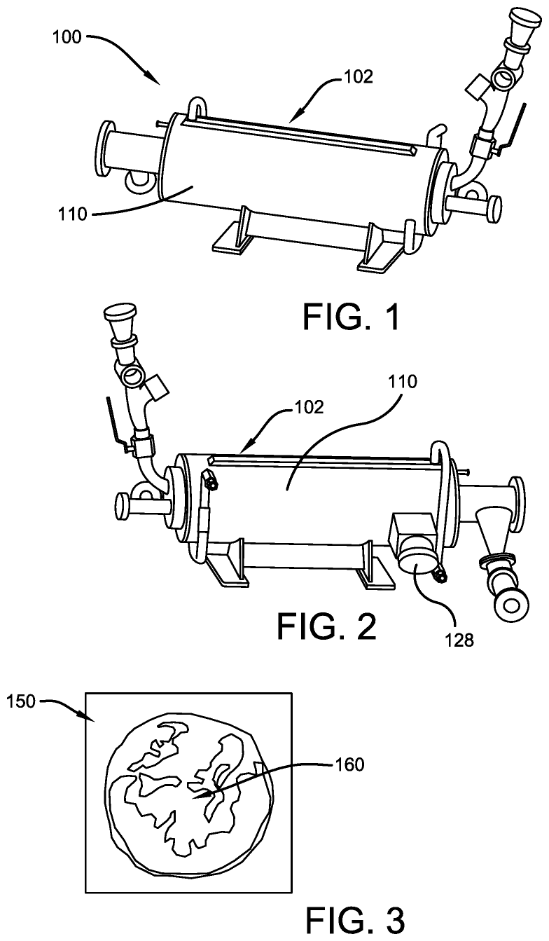

Referring initially to the drawings, FIGS. 1-6 illustrate a system 100 for processing waste material. The system 100 generates micro arcs and power micro impulses to treat the waste material. The system 100 may further be used to treat ore, solid materials, and to prepare and activate building mixtures. The system 100 comprises a tubular reactor 102 and a plurality of ferromagnetic elements 160. The system provides for the passage of material, such as gases, solids, or liquids, through the tubular reactor 102 in which an inductor generates a rotating electromagnetic field. The tubular reactor 102 comprises a housing 110 and a pair of flanges 112 positioned at opposing ends of the tubular reactor 110. The tubular reactor 102 is generally 30 to 50 cm in diameter and 400 to 1200 cm in length, although it can be smaller or larger in dimension as needed.

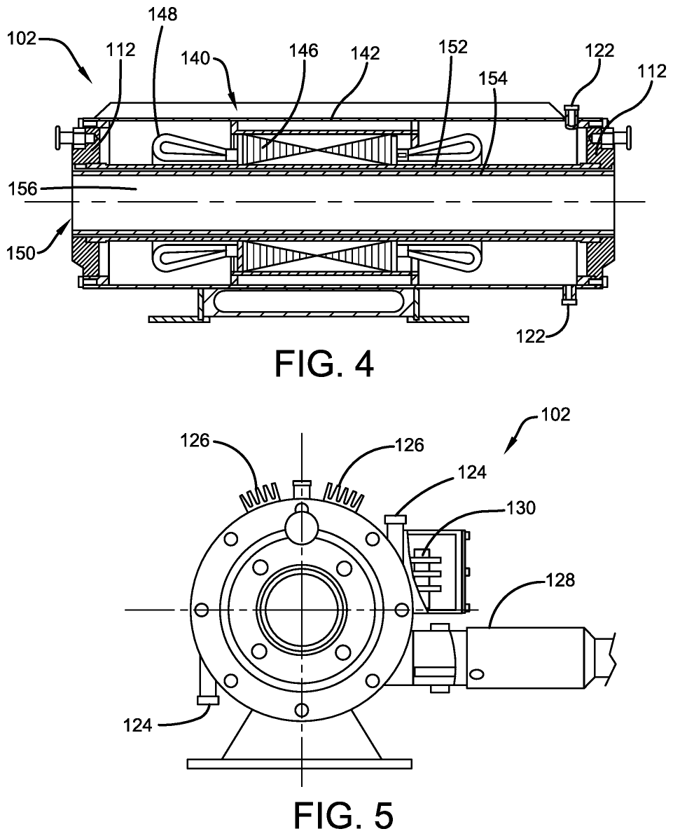

As illustrated in FIGS. 4 and 5, the tubular reactor 102 comprises a tubular chamber 150 and an inductor 140. The tubular chamber 150 comprises a shell 154 and a cylindrical working area 156. The cylindrical working area 156 is encapsulated by the shell 154. The shell 154 is magnetically nonreactive with the rotating electromagnetic field produced by the inductor 140. The shell 154 may be constructed from stainless non-magnetic steel AISI 321 or a basalt fiber. The tubular chamber 150 may further comprise a jacket 152. The jacket 152 may be an insulated sleeve or cooling jacket that lines the shell 154. The cooling jacket 152 is constructed to allow for the processing of waste substances at high temperatures up to at least 600 degrees Celsius.

The tubular reactor 102 further comprises control and thermal protection units, a frequency regulator of the supplied current from approximately 50 to 100 Hz, a power regulator installed in front of the inductor 140 in the range from approximately 5 to 100 kW with a continuous mode of its change, and a contactless phase switch with a switching frequency of approximately 50 to 100 periods per second. The tubular reactor 102 further comprises a power source 128 and a power regulator 130. The power regulator 130 is in electrical communication with the inductor 140. The tubular reactor 102 further comprises a reactor cooling component. The reactor cooling component is configured to cool the inductor 140. The reactor cooling component comprises a plurality of inlet pipes 122, a plurality of outlet pipes 124, and a plurality of fins 126 for containing a water-based or oil-based coolant. The tubular reactor can operate at a range of approximately five to 100 Kilowatts or higher.

The inductor 140 comprises a body 142, a magnetic core cassette 144, a magnetic circuit 146 and a winding 148. A core of the transformer of the inductor 140 may be laminated from electrical steel. The winding 148 is configured to generate the rotating electromagnetic field within the tubular working chamber 150 uniformly distributed and perpendicular to its axis. The winding 148 may be a symmetrical reduced two-layer loop, wire with oil-resistant insulation and operating temperature up to approximately to 200 degrees Celsius. Alternatively, the winding 148 may be constructed of wire with waterproof insulation with an operating temperature of up to approximately 90 degrees Celsius.

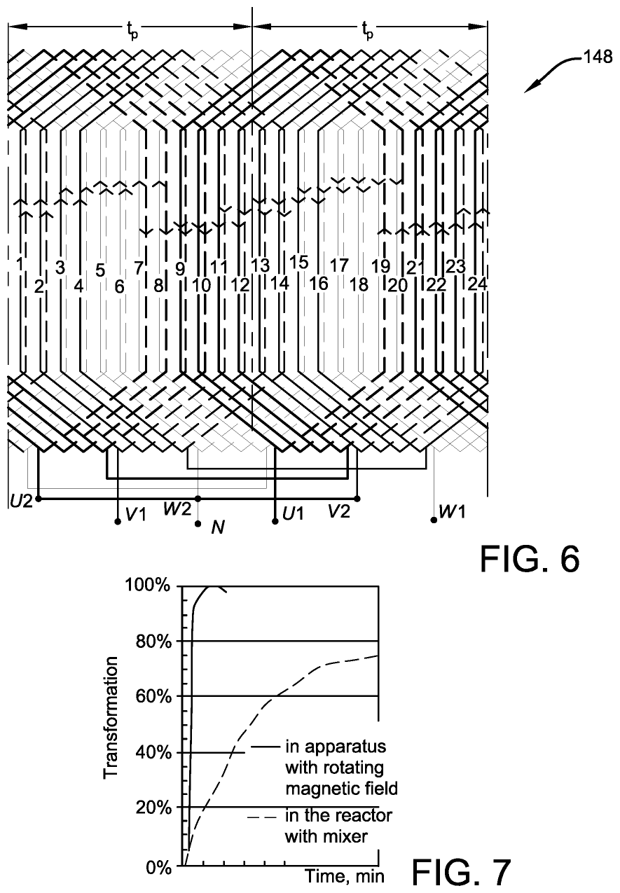

FIG. 6 illustrates a preferred winding scheme, where τp—indicates the pole pitch; V1, U1, W1—the beginning and V2, U2, W2—the ends of the phase windings, and N—neutral wire. The symmetrical two-layer loop reduced winding 148 ensures the symmetry of a three-phase inductor power supply system and improved magnetic field distribution in a stator core and the working chamber 156, equalizes magnetic field pulsations and electromagnetic system vibrations. A preferable range for the magnetic induction in the operating zone is from approximately 0.1 to 0.2 Tesla. The speed of rotation of the magnetic flux is preferably in the range from approximately 50 sec-1 to 100 sec-1, with the possibility of smooth adjustment. A core of the transformer of the inductor 140 may be constructed of extruded a composite ferromagnetic alloy.

The plurality of ferromagnetic elements 160 (hereinafter—“indenters”), are positional within the cylindrical working zone 156 of the non-magnetic tubular working chamber 150 that does not interact with the field. The plurality of ferromagnetic elements 160 are generally needle-shaped and configured to kinetically interact with the waste material when triggered by the rotating magnetic field generated by the inductor 140 as illustrated in FIG. 3. The activated plurality of ferromagnetic elements 160 generate the micro arcs and power micro impulses that kinetically treat the waste material.

As illustrated in FIG. 7, the processing results using a rotating magnetic field of the present invention and significantly better than those using a traditional mixer. Depending on the waste material to be treated, the plurality of ferromagnetic elements 160 may be coated with a can be coated with catalytic metals for certain processes (synthesis/distillation), or an elastic polymer shell to reduce contamination when processing substances with high purity requirements. The size of the ferromagnetic elements is most preferably in the range from 10 mm to 30 mm in length, and from 0.7 mm to 3 mm in diameter.

During their movement, the indenters continuously create micro arcs and power micro impulses, which in direct contact virtually no materials cannot withstand. The simultaneous influence of all these factors allows translating all processes in the working area 156 of the tubular reactor 102 into a kinetic mode, which in contrast to diffusion, inherent in all traditional processes, and, accordingly, dramatically increase the productivity of materials and media, increase the reaction rate, etc.

Under conditions of a strong electromagnetic field, powerful currents arise in the working bodies, leading to the formation of micro arcs when the micro circuits break during the rotational movement of the needles 160. Under the influence of the rotating magnetic field, the ferromagnetic elements 160 rotate with an accompanying change in polarity. With this magnetization reversal, there is a very rapid change in the discharge positions, entailing a rapid change in the linear size of the needles 160. As a result of these almost continuously emitted power impulses, a large force is applied to the environment (approximately 15 to 20 tons/mm2), acting over a small distance. In water, the extent or range of interaction of these pulses is several times larger than in solid-phase operations. When performing, the ferromagnetic elements 160 that fill the working chamber 156 gradually wear out, and the efficiency of the treatment process of necessary substances is reduced. Therefore, new indenters 160 are periodically supplied to the working chamber 156 by the dosing system 100, filling it with integral elements instead of the used ones. The indicator of filling of the working chamber 156 is the change of current of the phase winding 148 of the inductor 140, which is fixed by the devices and used by an automatic control system or operator.

When moving, the ferromagnetic working elements 160 continuously emit powerful local micro-impulses and micro-arcs (hereinafter “MIPMAP”). This action facilitates the intensive dispersion of any solid materials, as well as the mixing of the treated medium. Several effects are generated that combine with the local thermal and mechanical phenomena that occur when the ferromagnetic working elements 160 interact with a substance. The power of these effects is so great that, acting simultaneously on any particles of a substance, they provide structural and energy changes at the molecular and atomic level.

As a result of these interactions the wastewater to be treated is exposed to the following effects: particle dispersion; water ionization with separation of H+ and Hydroxyl Group OH−; weakening of intermolecular and interatomic bonds; oxidation/Reduction reactions (redox) by free radicals; magnetic field sustaining processes with highly ionized entities; magneto Hydrodynamic shocks comparable to cavitation processes or hydro-acoustic effects; intensive mixing; and localized thermal effects. The combined effect of all factors creates a very high level of activation of all components of the substance involved in the process. The reactions are no longer diffusion controlled but become a function of the discharge phenomena with associated increases in the rates of change or reaction kinetics. This process enables a rate increase in the treatment process by many orders of magnitude thereby reducing energy use and achieving processes previously considered unattainable.

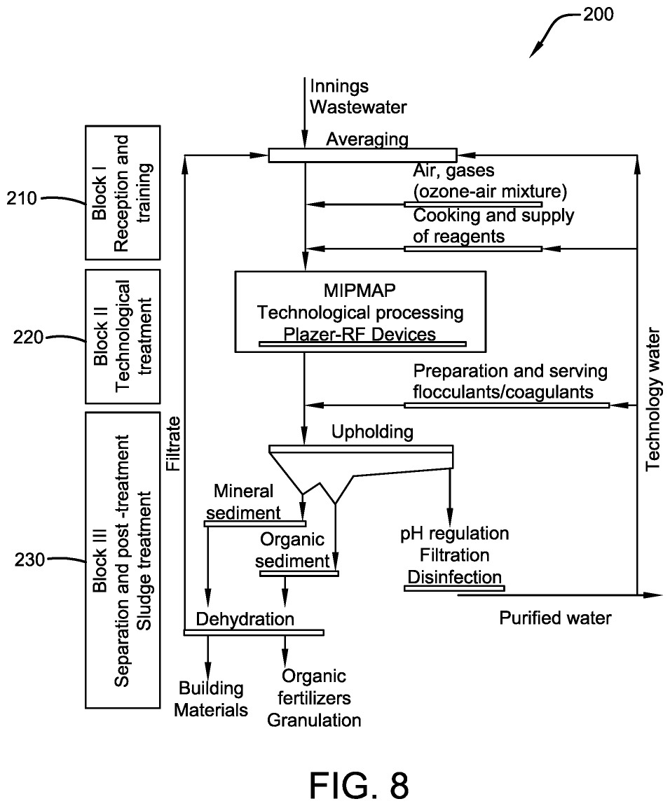

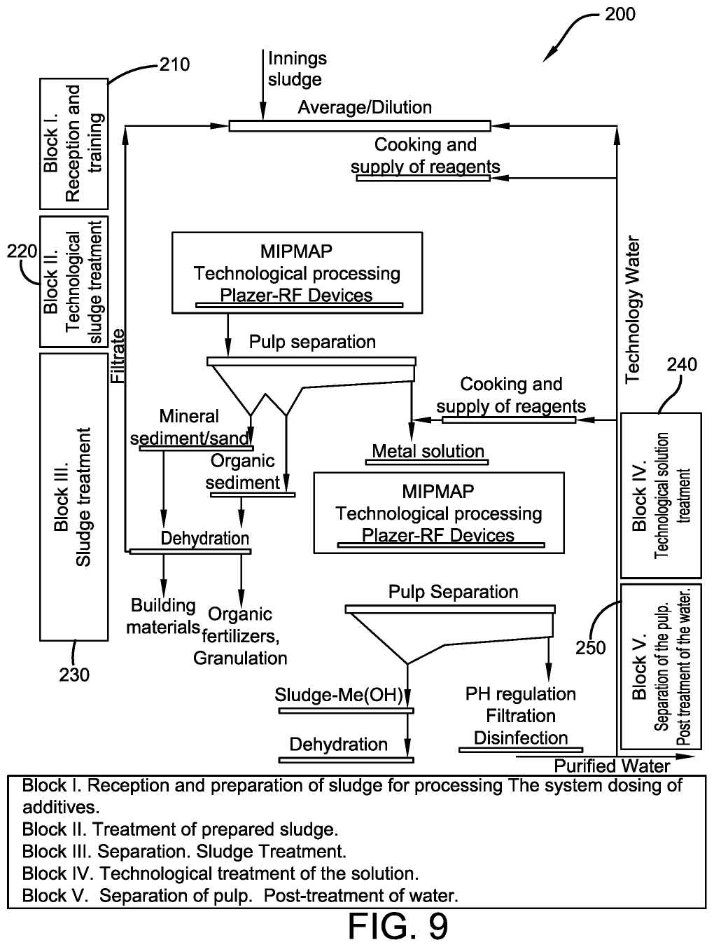

The subject matter disclosed and claimed herein, in another embodiment thereof as illustrated in FIGS. 8 and 9, comprises a method 200 for processing waste material using the system 100 for processing waste material. The system 100 generates micro arcs and power micro impulses to treat the waste material. The method 200 begins by pretreating the waste material using a traditional waste material treatment process at 210 which consists in the separation of magnetic components, separation of fat fractions, separation of solid particles and fragments for their further processing with a size of not more than 0.3-2.0 mm or their grinding to a size less than 0.3-2.0 mm Then the pretreated waste material is treated with the system 100 for processing waste material comprising the tubular reactor 102 and the plurality of ferromagnetic elements 160 at 220 using a rotating electromagnetic field using microarcs and power micro pulses at values of magnetic field induction in the working area of the tubular reactor, which contains ferromagnetic needle elements, not less than 0.1-0.25 T.

As discussed supra, the tubular reactor 102 comprises the tubular chamber 150 and the inductor 140. The tubular chamber 150 comprises the nonreactive shell 154 and the cylindrical working zone 156 encapsulated by the shell 154. The inductor 140 comprises the winding 148. The winding 148 is configured to generate the rotating electromagnetic field around the tubular working chamber 150. The plurality of ferromagnetic elements 160 are positional within the cylindrical working area 156 of the tubular working chamber 150. The plurality of ferromagnetic elements 160 are needle-shaped and configured to kinetically interact with the waste material when activated by the rotating magnetic field generated by the inductor 140. The ferromagnetic needle elements 160 may have a diameter of 0.5-1 mm and a length of 8-12 to intensify the mixing of liquid media, or liquid with gaseous media (including the formation of micro—(nanosized) bubbles), and also to increase the degree of solubility of miscible media (including gaseous media in liquids). Alternatively, the ferromagnetic needle elements 160 may have a diameter of 1-1.6 mm and a length of 12-20 mm to intensify the mixing of liquid media with solid particles with simultaneous dispersion (grinding) of these solid particles (including to obtain suspensions), as well as to intensify the mixing of liquid media, which are not prone to mixing and dissolving with each other, and to obtain emulsions. Alternatively, the ferromagnetic needle elements 160 may have a diameter of 1.6-3.2 mm and a length of 20-40 mm for intensification of dispersion (grinding) and mixing of solid materials, as well as for mixing (grinding) of liquid and semi-liquid materials (media) with increased values kinematic of viscosity greater than 0.155 in²/s (100 mm²/s). The ratio m/V of the mass of the ferromagnetic needle elements (m in grams) to the volume of the working area of the tubular reactor (V in cm³) may be selected from the range: m/V=0.1-0.4 g/cm³.

The activated plurality of ferromagnetic elements 160 generate the micro arcs and power micro impulses that kinetically treats the waste material. Depending on the waste material to be treated, the plurality of ferromagnetic elements 160 may be coated with a catalytic metal or an elastic polymer shell.

The method 200 continues at 230 by separating the treated waste material into usable component materials which comprises subsequent separation of the obtained fractions (products) after treatment of waste in a rotating electromagnetic field using microarcs and power micro pulses. The method 200 may further comprises retreating at least a portion of the treated waste material with the system 100 for treating waste material at 240. Once retreated, the retreated waste material is separated into usable component materials at 250.

The processes in the reactor can be enhanced by the addition of chemical additives comprising sources of hydrogen and hydroxide ions that can become reactive entities in the reaction zone such as the formation of superoxide and super hydrogen ions and other energized species. These reagents are not limited to hydrogen and hydroxide entities but can include other chemicals gases, liquids and solids that decompose or react to form energized entities in the reaction zone of the MIPMAP reactor.

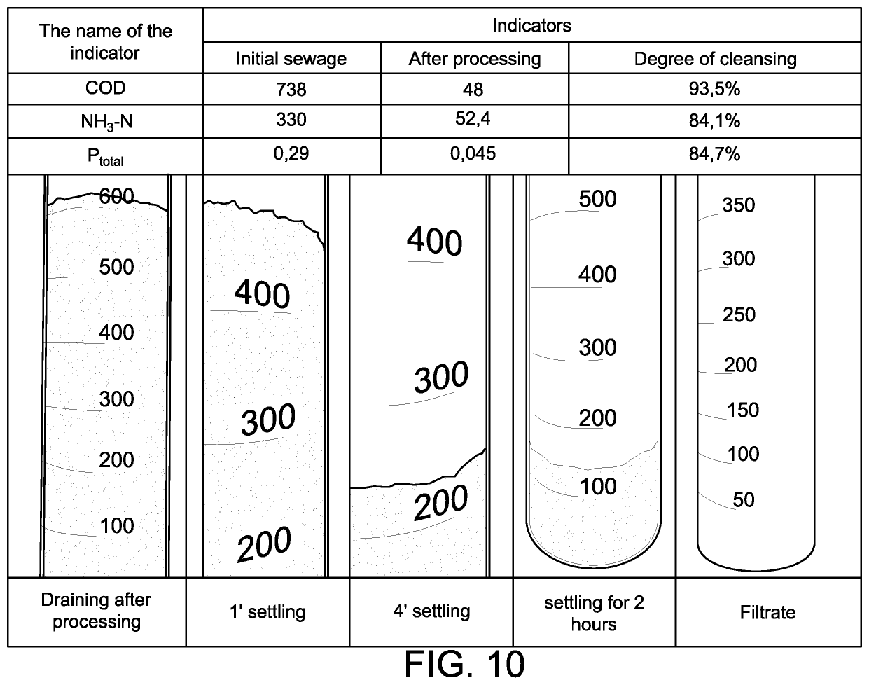

This unique combination of processes leads to accelerated chemical and physical interactions with rapid kinetics for the treatment processes. These are of both macro-duration and micro-duration. The outcomes from these complex reactions are that complex solids are formed with oxidation of heavy metals and removal of organic materials either through polymerization, breakdown, or adsorption. As illustrated in an example of a study on the wastewater treatment of fish processing enterprises shown in FIG. 10, the resultant water is free of living microbial organisms, trace organics, and heavy metals and suitable for most forms of re-use. The separated solid waste stream can be further treated for beneficial reuse or resource recovery, especially for nutrients. The solids removed are only that in the original wastewater with no added chemicals or biological by-products or sludges. The equipment of the present system provides a continuous flow through treatment of up to 10 m³/hr for each unit. Pretreatment requires grinding or settling to remove gross solids (solids to less than 2 mm and preferably around 500 microns) and post treatment with settling/filtration to remove solids.

The effect and advantages of micro arc processing in rotating magnetic fields using the system 100 and method 200 of the present invention is illustrated in several examples. The effect of micro arc processing in rotating magnetic fields on the content of poultry plants of microorganism organisms and cultures (as shown by the indicator organisms Escherichia coli and Staphylococcus aureus) in industrial wastes (litter) is provided in Table 1.

TABLE 1

| No. | Material | E-coli | St-aureus |
|---|---|---|---|
| 1 | Initial droppings of poultry farms | 10⁶ | 10⁶ |
| | (without processing) | | |
| 2 | The product after micro impulse | 0 | 0 |
| | microarc processing of droppings | | |
| | in rotating magnetic fields | | |

Determination of epidemic safety indicators of surface water for cattle manure is illustrated in Table 2.

TABLE 2

| | | Number of | Escherichia | |
|---|---|---|---|---|
| | | enterococci, | coli index, | Coli- |
| No. | Material | CFU in L | CFU in L | index |
| 1 | Initial cattle manure | 69 × 10³ | 15 × 10⁶ | 930 × 10⁶ |
| | (without processing) | | | |
| 2 | The product after micro | Is not | Is not | Is not |
| | impulse microarc | detected | detected | detected |
| | processing (MIPMAP) | | | |

Effective wastewater treatment for galvanic production (Cr and Ni coating lines) using MIPMAP is illustrated in Table 3.

TABLE 3

| | Indicators, mg/l | | |
|---|---|---|---|
| | | | Degree |
| Indicators | Initial | After | of |
| name | sewage | processing | cleaning |
| COD | 264 | <0.2 | 99.9% |
| Cr total | 1.9 | 0.248 | 87.0% |
| Fe total | 440 | 0.07 | 99.9% |
| Ni | 16.3 | 0.5 | 97.0% |
| Zn | 1140 | 1.5 | 99.86% |
| Suspended particles | 108 | <4 | 96.3% |
| Oil Products | 13.0 | 0.17 | 98.7% |

Example of sludge sites processing from septic tanks of city aeration plant using devices for microarc processing in rotating magnetic fields. The composition of the initial sludge after the municipal wastewater treatment plants and after processing using MIPMAP technology is illustrated in Tables 4-5.

TABLE 4

| Water | | Organic | | N, | | | | | | | | | | | |
|---|---|---|---|---|---|---|---|---|---|---|---|---|---|---|---|
| content | | matters | Sand | total | P, | K, | Metals, mg/kg | | | | | | | | |
| % | pH | % | % | % | % | % | Sb | Hq | Pb | Cd | Ni | Cr | Mn | Zn | Cu |
| 82.6 | 7.4 | 35.6 | 30 | 2 | 3.7 | 0.03 | 38.5 | 5.0 | 224 | 118 | 164 | 3,635 | 462 | 5,840 | 1,306 |

TABLE 5

| | | Elements, mg/kg | | | | | | | | |
|---|---|---|---|---|---|---|---|---|---|---|
| Products | Units | Sb | Hg | Pb | Cd | Ni | Cr | Mn | Zn | Cu |
| Sewage sludge | mg/kg | 38.5 | 5 | 224 | 118 | 164 | 3,635 | 462 | 5,840 | 1,306 |
| (initial sludge) | | | | | | | | | | |

Derived products from sewage sludge

| | | | | | | | | | | |
|---|---|---|---|---|---|---|---|---|---|---|
| Organic sediment | mg/kg | — | — | 0.06 | 0.004 | 0.03 | 0.1 | 0.2 | 0.08 | 0.6 |
| (organic fertilizer) | | | | | | | | | | |
| Metallic | mg/kg | 120 | — | 2,900 | 330 | 4,400 | 5,100 | 7,600 | 3,400 | 3,100 |
| concentrate | | | | | | | | | | |
| (metal hydroxide | | | | | | | | | | |
| sediment) | | | | | | | | | | |
| Recycling water | mg/l | — | — | 0.05 | — | 0.25 | 0.01 | — | — | 0.40 |

The metal content in the solution at various durations of cementation by iron is illustrated in Table 6.

TABLE 6

| | Metal content in solution, mg/L | | | |
|---|---|---|---|---|
| Metals | original solution | after 5 sec | after 10 sec | after 60 sec |
| Pt | 10 | 3.700 | 0.013 | 0.0 |
| Pd | 10 | 0.043 | 0.000 | 0.0 |
| Ir | 10 | 0.350 | 0.024 | 0.0 |
| Rh | 10 | 1.820 | 1.820 | 1.5 |

Exemplary areas of application of micro pulse micro arc processing in rotating magnetic fields (MIPMAP) are illustrated in Table 7 (NQ—indicates a positive increase but not quantified—process dependent)

TABLE 7

| | | Increase in specific indicators of | | | |
|---|---|---|---|---|---|
| | | traditional technologies (q-ty times) | | | |
| | Traditional | | Reduction | Reduced | |
| | technologies | Pro- | of metal | power | |
| | or | ductivity | con- | con- | Additional |
| Technology | equipment | growth | sumption | sumption | indicators |
| Mining | Methods of | NQ | NQ | NQ | Replace bulky |
| chemistry | hydrometallurgy | | | | vats and columns |
| | | | | | with compact |
| | | | | | plants and |
| | | | | | hydrocyclones |
| Extraction of | Acid dissolution, | 800- | NQ | NQ | A mobile line is |
| valuable | solvent extraction | 1,000 | | | provided to the |
| components | electrochemistry | | | | development site |
| from ores with | | | | | |
| a low content of | | | | | |
| elements such | | | | | |
| as tungsten, | | | | | |
| gold, etc. | | | | | |
| Processing of | Traditional | NQ | NQ | NQ | The yield is 5 to |
| dumps for the | processing | | | | 10 times higher. |
| purpose of | systems | | | | Capital costs are |
| extracting | (hydrometallurgy) | | | | 20-100 times |
| valuable | | | | | lower. |
| impurities | | | | | |
| (gold, copper, | | | | | |
| nickel, etc.) | | | | | |
| Powder | Vibro- and ball | 100-200 | 15-20 | 100-120 | The grinding |
| metallurgy: | mills Mixers | 80-100 | 15-20 | 100-120 | speeds increase |
| a) grinding, | For iron | 2-3 | Comparable | 5-6 | sharply; the |
| obtaining | 1500 degrees C. | 100-120 | Comparable | 100-120 | powder is |
| nanopowders | in atmosphere H₂ | | | | activated. |
| [symbol] )mixing | | | | | Very high |
| [symbol] ) sintering | | | | | quality mixing |
| [symbol] ) production | | | | | The sintering |
| of metal | | | | | temperature is |
| plastics | | | | | reduced by 100- |
| | | | | | 200° C. |
| | | | | | Sintering without |
| | | | | | protection at a |
| | | | | | temperature of |
| | | | | | 100-140° C. |
| Manufacture of | There are no | — | — | — | Sand is |
| waterproof | analogues | | | | processed with |
| sand for | | | | | additives at |
| waterproofing | | | | | normal |
| (hydrophobic | | | | | temperature and |
| materials) | | | | | pressure |
| Chemical | At high | NQ | NQ | NQ | The processes |
| industry | temperatures | | | | take place at low |
| a) | and pressures | | | | temperatures and |
| Homogeneous | using special | | | | pressures, which |
| processes | equipment | | | | makes it possible |
| b) | | | | | to simplify the |
| heterogeneous | | | | | equipment. The |
| processes | | | | | reaction rates are |
| | | | | | increased, this |
| | | | | | leads to a |
| | | | | | reduction in the |
| | | | | | range and size of |
| | | | | | the equipment. |
| Electronic | Vibro- and ball | NQ | NQ | NQ | Enhancing the |
| industry, | mills Mixers | | | | characteristics of |
| Activation, | | | | | electronic |
| grinding of | | | | | components and |
| ceramic | | | | | materials |
| materials for | | | | | |
| electronic | | | | | |
| components, | | | | | |
| boards, etc. | | | | | |
| Neutralization | Volumetric | 250 | 10000 | Up to 10 | Reduction of |
| and utilization | accumulators of | | | | the content of |
| of bilge water | oil-containing | | | | petroleum |
| on ships and in | water | | | | products up to |
| ports. | | | | | MPC |
| Manufacture | Ball and roller | NQ | NQ | NQ | The quality of |
| of oil and | mills | | | | oil paints |
| facade paints | | | | | corresponds to |
| | | | | | the |
| | | | | | specification, |
| | | | | | facade—above. |
| Production of | Feed-processing | 5-10 | 5000- | Comparable | Granules with low |
| mixed fodders | plants | | 10000 | | production costs |
| from local raw | | | | | were obtained |
| materials | | | | | |
| Extraction of | Extraction takes | NQ | NQ | NQ | The extraction |
| essential oils, etc. | place at long | | | | takes place at |
| from field plants | exposures in | | | | room temperature |
| | alcohol and oils | | | | and the oils are not |
| | | | | | damaged |

Among the benefits and advantages of the innovative technology of the present invention is the possibility of complete sewage utilization to get commercial products, including purified water, organic fertilizers, purified fine sand, and metal concentrates. Biological treatment systems do not achieve complete cycle of sewage disposal, as there is a need of additional disposal of sludge, including its disinfection and dehydration. At the same time, there is a problem of cleaning heavy metals from the sludge which cannot be solved on site in most cases. A very important advantage of the innovative technology is the dispensing of the necessity for sludge beds. These can occupy tens and hundreds of acres in large biological treatment plants and can cause extensive damage to ecology. In addition, the equipment for microarc processing in rotating magnetic fields differs from conventional technology by using significantly lower materials intensity and lower power intensity for the purification process.

The subject matter disclosed and claimed herein, in another embodiment thereof as method for processing constructional material mixture using the system 100 for processing material. The system 100 generates micro arcs and power micro impulses to treat the constructional material mixture. The method begins by treating the constructional material mixture with the system for processing material using a rotating electromagnetic field using microarcs and power micro pulses at values of magnetic field induction in a working area of a tubular reactor. The system 100 comprises the tubular reactor 102 and the plurality of ferromagnetic elements 160 and uses a rotating electromagnetic field using microarcs and power micro pulses at values of magnetic field induction in the working area of the tubular reactor, which contains ferromagnetic needle elements, not less than 0.1-0.25 T. The constructional material mixture may comprise sand and cement, or other building components.

As discussed supra, the tubular reactor 102 comprises the tubular chamber 150 and the inductor 140. The tubular chamber 150 comprises the nonreactive shell 154 and the cylindrical working zone 156 encapsulated by the shell 154. The inductor 140 comprises the winding 148. The winding 148 is configured to generate the rotating electromagnetic field around the tubular working chamber 150. The plurality of ferromagnetic elements 160 are positional within the cylindrical working area 156 of the tubular working chamber 150. The plurality of ferromagnetic elements 160 are needle-shaped and configured to kinetically interact with the constructional material mixture when activated by the rotating magnetic field generated by the inductor 140. The ferromagnetic needle elements 160 may have a diameter of 0.5-3.2 mm and a length of 8-40 to intensify the mixing.

The activated plurality of ferromagnetic elements 160 generate the micro arcs and power micro impulses that kinetically treats the constructional material mixture. Depending on the constructional material mixture to be treated, the plurality of ferromagnetic elements 160 may be coated with a catalytic metal or an elastic polymer shell.

The method continues by separating the treated constructional material mixture into usable component materials which comprises subsequent separation of the obtained fractions (products) after treatment of the constructional material mixture in a rotating electromagnetic field using microarcs and power micro pulses. The method may further comprises retreating at least of portion of the treated constructional material mixture with the system for processing material. Once retreated, the retreated constructional material mixture is separated into usable component material.

Constructional mixtures in a required proportion are passed through a tubular reactor, where inductor generates a high-energy rotating electromagnetic field. Ferromagnetic elements of needle shape are put in the working cylindrical area of the reactor/inductor. These ferromagnetic working elements oscillate, reaching several thousand periods per second. Electric circuits are formed for a short time period, where strong currents arise, forming temporary circuits. When these chains or circuits break, a large number of electrical microarcs appear. When moving, ferromagnetic working elements continuously emit powerful local micro pulses and micro arcs. This action contributes the intensive mixing of the treated mixture, as well as the chipping of oxide films of any solid materials. The process destroys oxide films along fracture lines or along microcrack lines. A powerful local shock impulse which comes from the working elements affects the material or mixture being processed. As a result, the treated material acquires other beneficial properties.

Under the influence of a rotating magnetic field, the ferromagnetic elements rotate with a corresponding change in polarity. With such magnetization reversal, a very rapid change in geometric dimensions occurs along with the phenomenon of magnetostriction. As a result of these almost continuously emitted power pulses, a large short distance force is applied to the environment (15-20 tons/mm2) As a result of these interactions, cement and other constructional mixtures are exposed to particle grinding; surface opening and removal of oxide and hydroxide films from the particle surface, sand and cement particles acquire electric charge; glued cement particles activity recovery, processes of interaction of the magnetic field with highly ionized objects; magnetostrictive shocks comparable to cavitation processes, and localized thermal effects.

There are several effects that are combined with local thermal and mechanical phenomena arising as a result of the interaction of ferromagnetic working elements with mixture. The power of these effects is so great that, acting simultaneously on any particle of mixture, they provide structural and energy changes at the molecular and atomic levels. The combined action of all factors creates a very high level of activation of all components of the substance that are involved in the process. Reactions are no longer controlled by diffusion, but become a function of discharge phenomena with a corresponding increase in the rate of change or reaction kinetics. This process makes it possible to increase many times the processing speed, thereby reducing energy consumption and achieving processes that were previously considered unattainable. This unique combination of processes results in accelerated chemical and physical interaction with fast kinetics of processing. Processes come in both macro durations and micro durations.

These complex interactions produce solid materials with other (new) chemical and physical properties. Experimentation has shown according to preliminary analyzes of prototypes, the treated mixture of sand and cement in the ratio of 15:5 and 2 parts of water, after the final solidification (after 28 days) showed the following results: non-treated prototypes before disruption had a compression of 400 psi with bending at 440 psi, and treated prototypes before disruption had a compression 2850 psi and a bending 1140 psi.

Due to the use of this technology, the performance indicators of compression and bending of constructional mixtures and concrete is significantly improved. This allows to reduce the amount of one of the most expensive components of constructional mixtures, which is cement, or increase the brand of constructional mixtures and concrete. All this leads to a reduction in the cost and weight of building structures while performing the same duty tasks. This also leads to a reduction of transportation costs and reduction of extracted raw resources.

The subject matter disclosed and claimed herein, in another embodiment thereof as method of recovering minerals and metals using the system 100 for processing material. The system 100 generates micro arcs and power micro impulses to treat ores, slags, or tailings. The method begins by treating ores, slags, or tailings with the system for processing material using a rotating electromagnetic field using microarcs and power micro pulses at values of magnetic field induction in a working area of a tubular reactor. The method continues by separating and recovering the minerals and metals from the treated ores, slags, or tailings. The system 100 comprises the tubular reactor 102 and the plurality of ferromagnetic elements 160 and uses a rotating electromagnetic field using microarcs and power micro pulses at values of magnetic field induction in the working area of the tubular reactor, which contains ferromagnetic needle elements, not less than 0.1-0.25 T.

As discussed supra, the tubular reactor 102 comprises the tubular chamber 150 and the inductor 140. The tubular chamber 150 comprises the nonreactive shell 154 and the cylindrical working zone 156 encapsulated by the shell 154. The inductor 140 comprises the winding 148. The winding 148 is configured to generate the rotating electromagnetic field around the tubular working chamber 150. The plurality of ferromagnetic elements 160 are positional within the cylindrical working area 156 of the tubular working chamber 150. The plurality of ferromagnetic elements 160 are needle-shaped and configured to kinetically interact with the constructional material mixture when activated by the rotating magnetic field generated by the inductor 140. The ferromagnetic needle elements 160 may have a diameter of 0.5-3.2 mm and a length of 8-40 to intensify the mixing.

The activated plurality of ferromagnetic elements 160 generate the micro arcs and power micro impulses that kinetically treats the ores, slags, or tailings. Depending on the ores, slags, or tailings to be treated, the plurality of ferromagnetic elements 160 may be coated with a catalytic metal or an elastic polymer shell.

The method continues by separating the treated ores, slags, or tailings into usable minerals and metals which comprises subsequent separation of the obtained fractions (products) after treatment of the ores, slags, or tailings in a rotating electromagnetic field using microarcs and power micro pulses. The method may further comprises retreating at least of portion of the treated ores, slags, or tailings with the system for processing material. Once retreated, the retreated ores, slags, or tailings are separated into usable minerals and metals.

When the working ferromagnetic elements(inductors) rotate, polarity changes in a strong magnetic field—there is magnetization reversal at very high velocities. As a result, there are continuously emitted power impulses. A large force results as a localized effect of the order of 15 to 20 tons/mm² acting over a small distance. There are secondary shock waves in some media. As a result, the materials are exposed to the following effects: mechanical impacts from working bodies; hydrodynamic, expressed as large shear stresses in the fluid, induced turbulence, pressure pulses and microflow velocity changes, hydroacoustic in liquid media due to small-scale pressure pulses, intense cavitation, shock waves and secondary nonlinear acoustic effects, micro-arc and electromagnetic field of vortex current, hydrolysis reactions, and thermal effects.

A few effects are generated that combine with the local thermal and mechanical phenomena that occur when the working bodies interact with a substance. The power of these effects is so great that, acting simultaneously on any particles of a substance, they provide deep structural and energy changes. The combined effect of all factors creates a very high level of activation of all components of the substance involved in the process.

Traditional technologies such as initial grinding, milling, floatation, solvent chelating or acid leaching followed by precipitation are multi-stage processes with intensive use of chemicals, energy and other materials such as water. An additional issue is the treatment of wastewater and disposal of the treated water and byproducts. All traditional operations requiring direct contact of the ore with a solution are also relatively slow and of low efficiency. The present invention allows for improved recovery of valuable resources from processing ores, slags, and tailings.

The system 100 can be used to accelerate the dissolution and leaching processes and to increase the level of extraction of the target components from the ore without increasing the residues. The effectiveness of this process with this non-traditional technology and processing also enables profitable recovery of target elements from low grade ores, tailings dump and mine waters. Traditional processes for grinding of ores and concentrates in ball and rod mills are time consuming and energy intensive. The grind output size is limited to several hundred microns unless multiple passes are used to fully expose finely disseminated ores.

With the system 100, most minerals can be milled to several microns in a single pass. This opens up new possibilities for a more complete extraction of minerals. The time for production is lowered with lowered use of energy, water, and reduced noise. The system 100 also enhances metal recovery particularly at very low levels using hydrometallurgical cementation processes. Experimental evidence, as shown below in Table 8, has established that in the presence of iron or nickel, ores process with the system 100 provide for high levels of recovery of copper, gold, silver, arsenic, platinum, and other metals from solution at a rapid rate.

TABLE 8

| | Metal content in solution, mg/L | | | |
|---|---|---|---|---|
| Metals | original solution | after 5 sec | after 10 sec | after 60 sec |
| Pt | 10 | 3.700 | 0.013 | 0.0 |
| Pd | 10 | 0.043 | 0.000 | 0.0 |
| Ir | 10 | 0.350 | 0.024 | 0.0 |
| Rh | 10 | 1.820 | 1.820 | 1.5 |

A major advantage of using the system 100 in the processing of all grades of metal ores is the combination of two operations: leaching and metal separation from solutions. This leads to a significant increase in the efficiency of ore processing including those fractions of ore bodies traditionally regarded as unreactive, inert or inaccessible. Flotation can be carried out with the system 100 with a much greater effectiveness than with traditional technology processes design. For example, in the preparation of grinding clay sludge from floated minerals, the activation of their surfaces and the uniform distribution of all components in the pulp, including flotation reagents, are carried out in the system 100 working area in a matter of seconds. The preparation of pulp in traditional mixers leads to a significant cost overrun of flotation reagents.

The main operations of the technological processes are: single pass milling of ore from 15-20 mm to less than 100 microns using the system 100 (or with multiple passes to the size required for optimum leaching/extraction characteristics); processing of pulp slurry in the system 100 equipment with required reagents and extraction of metals contained in the ores into solution.; separation of the mineral component from solution by sedimentation as an accelerated process, 3 to 10 times faster than compared with traditional methods; and separation of one or group of metals from the solution. The system 100 is usable in a variety of methods of applying energy to matter in the working zone, the energy of a rotating electromagnetic field of high specific concentration with simultaneous exposure to ferromagnetic bodies. Determination of parameters and values is illustrated in Table 9.

TABLE 9

| Parameters | Values |
|---|---|
| Water performance, m³/h: | Up to 12 m³/h |
| Mains supply, V/Hz | 3-phase: |
| | 400 V −15% + 10%; 50/60 Hz |
| Mains supply current, A | 8-20 |
| Input power (active), kW | 2-9 |
| Operating zone diameter, mm | 95 |
| Field density in operation zone, T | 0.09-0.18 |
| Inductor working frequency range, Hz | 40-100 |
| Inductor operating voltage range, V | 280-400 |
| Cooling fluid | transformer oil, |
| | Water |
| Inductor dimensions (diameter, length), m | 0.3/0.8 |
| Weight (including inverter, without | Up to 170 |
| cooling system), kg | |

In essence, the technology if the passage of a material, solid, liquid, or as, through the tubular reactor in which an inductor generates a rotating electromagnetic field. Ferromagnetic elements(indenters) that are needle shaped are placed in the working cylindrical zone of the inductor/reactor. The working elements oscillate, reaching several thousand periods per second. For a short time, electric circuits are formed in which strong currents arise to form temporary chains. When these chains break, many micro-arcs arise. When moving, the working bodies continuously emit powerful local micro-impulses and micro-arcs. This facilitates intensive mixing of the media being treated and the dispersal of materials. The high-powered local shock impulse action from the chain breaks acts on the material being treated.

Several effects are generated that combine with the local thermal and mechanical phenomena that occur when the working bodies interact with a substance. The power of these effects is so great that, acting simultaneously on any particles of a substance, they provide deep structural and energy changes. The combined effect of all factors creates a very high level of activation of all components of the substance involved in the process. The reactions no longer are diffusion controlled but become a function of the discharge phenomena with associated increases in the rates of change or reaction kinetics. This process enables a rate increase in the treatment process by many orders of magnitude thereby reducing energy use and achieving processes previously considered unattainable.

When the working ferromagnetic elements(inductors) rotate, polarity changes in a strong magnetic field there is magnetization reversal at very high velocities. As a result, there are continuously emitted power impulses. A large force results as a localized effect of the order of 15 to 20 tons/mm² acting over a small distance. There are secondary shock waves in some media. As a result, the materials are exposed to the following effects; mechanical impacts from working bodies, hydrodynamic, expressed as large shear stresses in the fluid, induced turbulence, pressure pulses and microflow velocity changes, hydroacoustic in liquid media due to small-scale pressure pulses, intense cavitation, shock waves and secondary nonlinear acoustic effects, micro-arc and electromagnetic field of vortex current, hydrolysis reactions, and thermal effects.

The technological and operational advantages of the equipment based on the methods and system 100 are due to the high intensity of the processes taking place in the working area of the apparatus. There are complex reactions associated with these changes that are believed to include intensive dispersion of particles and components and their mixing, water ionization with separation of ions H+ and hydroxyl group OH−, weakening intermolecular and interatomic bonds by destructuring flows as a result of action of electromagnetic lens of the inductor, and oxidation and reduction of several compounds.

A comparison of the kinetics of oxidation chemical reactions in a heterogeneous system in reactors and in the system 100 is illustrated in Table 10 below.

Due to the high mixing efficiency, operational delivery of the system reactions occurs nearly simultaneously. Under the influence of shock waves, solid particles are very quickly pulverized. The pulverization process proceeds continuously and with increasing effect speed throughout the volume. Each solid particle has a surface film of oxides, impurities, and reaction products which would generally slow the reactions. As a result of the continuous destruction of large and small particles, new cleavage surfaces are continuously formed that are not protected by such films. This significantly increases the chemical reactivity of the solid component. The shock waves from the inductors also disperses these films.

The oxidation reaction in the system 100 occurs in seconds as shown above. The kinetics appear as a straight line after a slower initiation period. The process ends in 1 to 2 min. In a similar reactor with mixer alone, the oxidation is much slower. The resultant smooth curve shows that the reaction does not reach an end point but becomes asymptotic. This is attributed to the formation of new products slowing the reaction process.

A second important factor is the reduction in the overall dimensions of the secondary processing equipment, such as the sedimentation tanks. The treated materials leaving the working reactor have acquired new properties. They settle several times faster, and the precipitate and the solution above it have a clear interface. For example, there is no transition layer of colloidal or dispersed material as the colloidal suspension effect is eliminated.

The use of the system 100 enables a re-thinking of traditional treatment processes. Every phase of processing has improved efficiency accompanied by smaller plant sizes, lowered chemical consumption costs and final processing. The level of efficiency is believed to be such that it becomes profitable to develop processing of small deposits of rare metals in remote areas that do not have developed infrastructure. The system 100 is easily integrated into almost any traditional processing line without requiring significant alterations and capital costs, leading to increased production efficiency. The potential application also provides for improved environmental impacts with water re-use and recycling, non-leaching processed residues and reduced chemical consumption.

For ore and dumps processing with extraction of valuable components, dumps processing can be implement using two methods. The separation and recovery of the precious metal component in particulate form. This is applicable to the extraction of precious metals from tailings dumps. And separation or dissolution of precious elements as solutions, for example by chemical treatment. In the first case the system 100 reprocesses particulate waste to enable subsequent separation of the metal fine particles. However, the dumps may also contain rare elements—selenium, tellurium, silver, etc. However, if these residues are treated with reagents in the operating zone of the system 100, then these elements will dissolve and then can be easily removed as a solid phase.

From typical gold mine data, on average 10-12% of gold is not recovered. Selenium and tellurium are generally not extracted at all and go to the tailings dump. The typical screen size of crushed rock going to the tailings dump is 71 microns. This particle size is ideal for the final grinding by the system 100. Wet regrinding of dump materials is rational for the purpose of additional extraction of precious metals. Extraction of selenium and tellurium will be most effective using the method of acid leaching after or simultaneously with the separation of precious metals. The byproduct of after reprocessing will be finely ground powder of quartzite used in the production of steel and iron castings.

Grinding of silica sand with a particle size −63 microns in the system 100 provided powder size less than 20-25 microns, which goes far beyond the currently existing traditional grinding technologies. Moreover, it has been found that processing of silica sand in 5-8% sulfuric acid solution not only accelerated the process, but almost completely solubilized all the elements present. From typical gold mine data, on average 10-12% of gold is not recovered. Extraction of up to 80% of the gold contained in tailings can be expected using the system 100.

In an example of regrinding and separation of precious metals, associated components and finely ground quartzite without chemical treatment, ore after crushing (<20 mm) enters the a hopper and from it into grinders. The crushed ore is sieved on a sieve. The fraction (<350 μm) in a screw is mixed with water supplied by a pump from tank . The pump feeds the suspension into a reactor and then into the intermediate tank. In this tank, the largest and correspondingly heaviest particles of native metals are separated. It should be noted that ductile metals in the short time in the reaction area of the system 100 are not crushed, while carbides, nitrides, and oxides undergo very fine grinding. Consequently, only the heavy fraction will remain in the intermediate tank. The final purification is carried out in a hydraulic separator, which operates independently of the intermediate tank. Next, the suspension enters a system of active sedimentation tanks. Their operation is determined by the specific conditions of the minerals being processed.

The sludge coming from the first sump contains associated elements and is significantly enriched with metals. It gradually accumulates in the collectors. Each of the settlers is equipped with such a collector that works independently. If there is a need for a more complete separation by fractions, then the collected sludge is sent to the hydraulic separator. In the second sum, the metal content is already low, and the bulk consists of compounds of related elements. A lot of ground quartzite is also present. Almost pure ground quartzite, which takes the name of ‘marshallate’, comes from a fourth settler. The carrier is recycled water containing particularly fine solid particles of sand, collected in a container. The solid fraction gradually settles and is collected in a collection.

In another example of regrinding and separation of precious metals, associated components and finely ground quartzite using of chemical additives. The added reagent will not react with the precious metals. Therefore, only the two components will remain in the solid phase, precious metals and quartzite, which facilitates the separation.

Ore after crushing (<20 mm) enters a hopper and passes into grinders. The crushed ore is sieved. The fraction (<350 μm) in a screw is mixed with a solvent that is fed from tanks through dispensers. The resulting pulp (ratio T:W 1:4, 1:5) pump passes into the a reactor. The resulting suspension is fed into an intermediate tank, where the bulk of the precious metals are separated, and then accumulated in a collector. The supernatant is sent to an active sedimentation system, in which the precious metals and sand are separated from the solution and distributed along the collecting tanks. Sludge from the first collecting tank is enriched with precious metals, and in the last is almost only sand. There are typically a minimum of three collector tanks.

From the clarification tanks the solution comes to the collector tank. The supernatant solution is treated in a reactor and the elements are separated by methods of neutralization and precipitation. The slurry containing the metal compounds is collected in the collecting tanks, and purified water, is usually suitable to be directed to the head of the process meeting industrial water reuse standards. The final purification of metals is carried out in hydro cyclones or separators.

Advantages of the system 100 include accelerated final fine grinding and dissolution. The system 100 reduces operations to seconds and minutes, while with traditional methods, they often last for many hours. Typical performance is shown by conventional grinding of tungsten carbide in vibration mills which takes 96 hours while with system 100 it is only 10 to 12 minutes to achieve the equivalent product quality. Noticeable speed up of chemical reactions, a reduction in the consumption of additives, the consumption of electricity, and reduction in associated labor costs. Other advantages include: significant acceleration of settling/precipitation of the solid phase (95% drops in the first 5-8 minutes) The sediment and solution above it have a clear interface; increased output of valuable components; collection and separation of valuable components from dumps using the same equipment; obtaining finely ground quartzite suitable for use as foundry sands ‘Marshallit’, as a valuable by-product; there is no need to use high toxic regents for extraction of precious metals, including mercury and cyanide decrease in the volume of sedimentation tanks (by a factor of about 10), as well as the number of mixers, filters, auxiliary tanks suitability for deployment as mobile treatment sites, greatly reducing the time for development of the whole production; and areas are self-contained with zero discharge production that prevents discharges, the loss of potentially valuable components and complies with environmental regulations.

The equipment based on this innovative technology is very suitable for processing small deposits of valuable elements such as tungsten. In the absence of supporting infrastructure such as roads, major plant, power, and equipment these mobile equipment sites with the system 100 can be easily delivered to site and removed when it is finished with little environmental impact. Examples of potential applications include mining chemistry, extraction from minerals with low content, such as tungsten and gold, processing of tailings dumps to extract valuable residues, powder metallurgy, manufacture of sand for waterproofing (hydrophobic materials), the chemical and electronic industries, neutralization of formation water during the extraction of oil or gas and extraction of valuable components from them, and treatment of fuel oil.

Notwithstanding the forgoing, the system 100 can be any suitable size, shape, and configuration as is known in the art without affecting the overall concept of the invention, provided that it accomplishes the above stated objectives. One of ordinary skill in the art will appreciate that the shape and size of the system 100 and its various components, as show in the FIGS. are for illustrative purposes only, and that many other shapes and sizes of the system 100 are well within the scope of the present disclosure. Although dimensions of the system 100 and its components (i.e., length, width, and height) are important design parameters for good performance, the system 100 and its various components may be any shape or size that ensures optimal performance during use and/or that suits user need and/or preference. As such, the system 100 may be comprised of sizing/shaping that is appropriate and specific in regard to whatever the system 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of processing waste material using a system for processing waste material configured to generate a rotating electromagnetic field, the method comprising:
pretreating the waste material by separating out and reducing in size to 2.0 mm or less any magnetic components, fat fractions, solid particles, and fragments;
treating the pretreated waste material with the system for processing waste material using a rotating electromagnetic field using microarcs and power micro pulses at values of magnetic field induction in a working area of a tubular reactor; and
separating the treated waste material into usable products.

2. The method of claim 1 further comprising the step of retreating at least of portion of the treated waste material with the system for processing waste material.

3. The method of claim 2 further comprising the step of retreating at least of portion of the treated waste material with the system for processing waste material.

4. The method of claim 1, wherein the system for processing waste material comprises:
a tubular reactor comprising:
a tubular chamber comprising a cylindrical working area encapsulated within a nonreactive shell; and
an inductor comprising a winding configured to generate a rotating electromagnetic field within the tubular chamber uniformly distributed within and perpendicular to its axis;
a reactor cooling component for cooling the inductor; and
a plurality of needle-shaped ferromagnetic elements positional within the working cylindrical area configured to interact with the rotating electromagnetic field.

5. The method of claim 4, wherein the tubular reactor operates at a frequency of 50 to 100 Hertz.

6. The method of claim 4, wherein the tubular reactor operates at a switching frequency of 50 to 100 periods per second.

7. The method of claim 4 , wherein the winding is a symmetrical reduced two-layer loop.

8. The method of claim 4, wherein the plurality of ferromagnetic elements are needle-shaped.

9. The method of claim 4, wherein the plurality of ferromagnetic elements are coated with a catalytic metal or an elastic polymer shell.

10. A method of processing a constructional material mixture using a system for processing material configured to generate a rotating electromagnetic field, the method comprising:
treating the constructional material mixture with the system for processing waste material using a rotating electromagnetic field using microarcs and power micro pulses at values of magnetic field induction in a working area of a tubular reactor.

11. The method of claim 10, wherein the system for processing material comprises:
a tubular reactor comprising:
a tubular chamber comprising a cylindrical working area encapsulated within a nonreactive shell; and
an inductor comprising a winding configured to generate a rotating electromagnetic field within the tubular chamber uniformly distributed within and perpendicular to its axis;
a reactor cooling component for cooling the inductor; and
a plurality of needle-shaped ferromagnetic elements positional within the working cylindrical area configured to interact with the rotating electromagnetic field.

12. The method of claim 11, wherein the constructional material mixture comprises sand and cement.

13. The method of claim 12, wherein the system is configured to remove any oxide and hydroxide films from the sand and cement.

14. The method of claim 11, wherein the system is configured to apply a short distance force of between 15-20 tons/mm to the constructional material mixture.

15. The method of claim 11, wherein each of the plurality of needle-shaped ferromagnetic elements are less than 3 millimeters in diameter and less than 30 millimeters in length.

16. The method of claim 11 further comprising the step of retreating at least of portion of the treated constructional material mixture with the system for processing material.

17. A method of recovering minerals and metals from using a system for processing material configured to generate a rotating electromagnetic field, the method comprising:
treating ores, slags, or tailings with the system for processing material using a rotating electromagnetic field using microarcs and power micro pulses at values of magnetic field induction in a working area of a tubular reactor; and
separating the minerals and metals from the treated ores, slags, or tailings.

18. The method of claim 17, wherein the system for processing material comprises:
a tubular reactor comprising:
a tubular chamber comprising a cylindrical working area encapsulated within a nonreactive shell; and
an inductor comprising a winding configured to generate a rotating electromagnetic field within the tubular chamber uniformly distributed within and perpendicular to its axis;
a reactor cooling component for cooling the inductor; and
a plurality of needle-shaped ferromagnetic elements positional within the working cylindrical area configured to interact with the rotating electromagnetic field.

19. The method of claim 18, wherein the system is configured to mill the ores, slags, or tailings into a plurality of particles less than 100 microns in size in a single pass through the system.

20. The method of claim 18 further comprising the step of retreating at least of portion of the treated ores, slags, or tailings with the system for processing material.
